(19) United States
(12) Patent Application Publication
(10) Pub. No.: US 2017/0332000 A1
(43) Pub. Date: Nov. 16, 2017

(54) HIGH DYNAMIC RANGE LIGHT-FIELD IMAGING

(71) Applicant: Lytro, Inc., Mountain View, CA (US)

(72) Inventors: Zejing Wang, Mountain View, CA (US); Kurt Akeley, Saratoga, CA (US); Colvin Pitts, Snohomish, WA (US); Jon Karafin, Lyons, CO (US)

(21) Appl. No.: 15/150,679

(22) Filed: May 10, 2016

(51) Int. Cl. H04N 5/235; H04N 5/225

(52) U.S. Cl. CPC H04N 5/2355; H04N 5/2258; H04N 5/2356

(57) ABSTRACT

A high dynamic range light-field image may be captured through the use of a light-field imaging system. In a first sensor of the light-field imaging system, first image data may be captured at a first exposure level. In the first sensor or in a second sensor of the light-field imaging system, second imaging data may be captured at a second exposure level greater than the first exposure level. In a data store, the first image data and the second image data may be received. In a processor, the first image data and the second image data may be combined to generate a light-field image with high dynamic range.

### TECHNICAL FIELD

The present disclosure relates to systems and methods for capturing and processing light-field data, and more specifically, to systems and methods for capturing and processing high dynamic range light-field images.

### BACKGROUND

Light-field imaging is the capture of four-dimensional light-field data that provides not only spatial information regarding light received from a scene, but also angular information indicative of the angle of incidence of light received from the scene by the camera's optical elements. Such four-dimensional information may be used to project a variety of two-dimensional images, including images at various focus depths, relative to the camera. Further, the light-field information may be used to ascertain the depth of objects in the scene. Yet further, the light-field information may be used to enable and/or facilitate various image processing steps by which the light-field and/or projected two-dimensional images may be modified to suit user requirements.

In previously known techniques for light-field and conventional (two-dimensional) image capture, the dynamic range of the image has generally been limited. If the camera is calibrated to a high exposure setting, several pixels will be saturated, resulting in loss of comparative intensity data between the saturated pixels. Conversely, if the camera is calibrated to a low exposure setting, several pixels may be completely dark, resulting in loss of comparative intensity data between the dark pixels.

Some attempts have been made to capture high dynamic range images with conventional camera architecture. In some implementations, different portions of an image sensor are driven at different exposure levels. Two major problems occur with this approach. First, the effective resolution of the resulting image may be reduced due to the need to sample the additional dimension. Second, color artifacts may occur due to interaction of the sensor exposure with the color filter used to provide color differentiation.

### SUMMARY

A high dynamic range (HDR) light-field image may be captured through the use of a light-field imaging system. In a first sensor of the light-field imaging system, first image data may be captured at a first exposure level. In the first sensor or in a second sensor of the light-field imaging system, second imaging data may be captured at a second exposure level greater than the first exposure level. In a data store, the first image data and the second image data may be received. In a processor, the first image data and the second image data may be combined to generate a light-field image with high dynamic range.

A plenoptic light-field camera architecture may provide more options for providing color differentiation and/or exposure differentiation to enable capture of a high dynamic range image. Specifically, color differentiation and/or exposure differentiation may be carried out at the image sensor, at the aperture, and/or at the microlens array. Any combination of color differentiation and exposure differentiation techniques may be used.

In some embodiments, a camera array may be used to capture a high dynamic range light-field image. Each individual camera may have a particular color and/or exposure setting.

In addition to or in the alternative to the foregoing, temporal sampling approaches may be used to vary exposure over time. Capturing images at different exposure levels in rapid succession may provide the range of data needed to generate the HDR light-field image. Such rapid exposure level adjustment may be carried out through the use of electronic control of an image sensor and/or, through alteration of the transmissivity of the optical pathway through which light reaches the sensor.

### BRIEF DESCRIPTION OF THE DRAWINGS

The accompanying drawings depict several embodiments. Together with the description, they serve to explain the principles of the embodiments. One skilled in the art will recognize that the particular embodiments depicted in the drawings are merely exemplary, and are not intended to limit scope.

FIG. 1 depicts a portion of a light-field image.

FIG. 2 depicts an example of an architecture for implementing the methods of the present disclosure in a light-field capture device, according to one embodiment.

FIG. 3 depicts an example of an architecture for implementing the methods of the present disclosure in a post-processing system communicatively coupled to a light-field capture device, according to one embodiment.

FIG. 4A depicts an example of an architecture for a light-field camera for implementing the methods of the present disclosure according to one embodiment.

FIG. 4B depicts exemplary image space and object space in the context of conventional image capture, according to one embodiment.

FIG. 5 depicts a method of generating a high dynamic range light-field image, according to one embodiment.

FIGS. 6A through 6C depicts different options for providing color and exposure differentiation on the sensor, according to certain embodiments.

FIGS. 7A and 7B depict the use of a non-uniform pattern filter at the aperture, according to one embodiment.

FIG. 8 depicts nine combinations of color differentiation and exposure differentiation in a plenoptic light-field camera, according certain embodiments.

FIGS. 9A through 9D depict processing steps in the generation of a high dynamic range light-field image, according to one embodiment.

FIGS. 10A and 10B depict filter patterns that may be used in alternative embodiments.

FIG. 11 depicts the direct projection of a red color channel, a green color channel, and a blue color channel from the filter pattern of FIG. 10A, according to one embodiment.

FIG. 12 depicts application of a Bayer pattern to a microlens array, according to one embodiment.

FIG. 13 depicts application of a patterned ND filter to a microlens array, according to one embodiment.

FIGS. 14A and 14B depict light-field imaging systems in the form of camera arrays, according to certain embodiments.

FIG. 15 depicts twenty-seven combinations of color differentiation, exposure differentiation, and temporal exposure variation, according to certain embodiments.

FIGS. 16A and 16B depict exemplary electronically-controlled, sequential exposure configuration patterns, according to one embodiment.

### DEFINITIONS

For purposes of the description provided herein, the following definitions are used:
Camera array: a series of cameras arranged in a pattern such that the cameras cooperate to capture image data that can be combined into a single image.
Color differentiation, or color sampling: a method by which light received in a camera is divided into different colors.
Color differentiation element: a system or apparatus that carries out color differentiation.
Data store: a hardware element that provides volatile or nonvolatile digital data storage.
Disk: a region in a light-field image that is illuminated by light passing through a single microlens; may be circular or any other suitable shape.
Exposure differentiation, or exposure sampling: a method by which light received in a camera is divided into different exposure levels.
Exposure differentiation element: a system or apparatus that carries out exposure differentiation.
Exposure level: the degree to which a camera or components of a camera are sensitive to light.
Extended depth of field (EDOF) image: an image that has been processed to have objects in focus along a greater depth range.
Four-dimensional coordinate, or 4D coordinate: The coordinates (x, y, u, v) used to index the light-field sample. (x, y) may be referred to as the spatial coordinate and (u, v) may be referred to as the angular coordinate. In a plenoptic light-field camera, (x, y) is the coordinate of the intersection point of a light ray with the microlens array, and (u, v) is that with the aperture plane.
Image: a two-dimensional array of pixel values, or pixels, each specifying a color.
Image data: digital data captured at a sensor that contains at least a portion of an image
Image sensor, or photosensor: a sensor that produces electrical signals in proportion to light received.
Light-field, or light-field data: four-dimensional data, such as a sample representing information carried by ray bundles captured by a light-field camera or other capture device. Each ray may be indexed by a four-dimensional coordinate (for example, x, y, u, v). This document focuses on digital light-fields captured by a single light-field camera, with all samples arranged in a two-dimensional array as on their layout on a photosensor.
Light-field image: an image that contains a representation of light-field data captured at the sensor.
Microlens: a small lens, typically one in an array of similar microlenses.
Microlens array: a pattern of microlenses.
Plenoptic light-field camera: a camera that uses a microlens array to capture four-dimensional light-field data.
Transmissivity: the degree to which light is able to move along an optical pathway without attenuation.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art. One skilled in the art will recognize that many types of data acquisition devices can be used in connection with the present disclosure, and that the disclosure is not limited to cameras. Thus, the use of the term “camera” herein is intended to be illustrative and exemplary, but should not be considered to limit the scope of the disclosure. Specifically, any use of such term herein should be considered to refer to any suitable device for acquiring image data.

In the following description, several techniques and methods for processing light-field images are described. One skilled in the art will recognize that these various techniques and methods can be performed singly and/or in any suitable combination with one another.

### Architecture

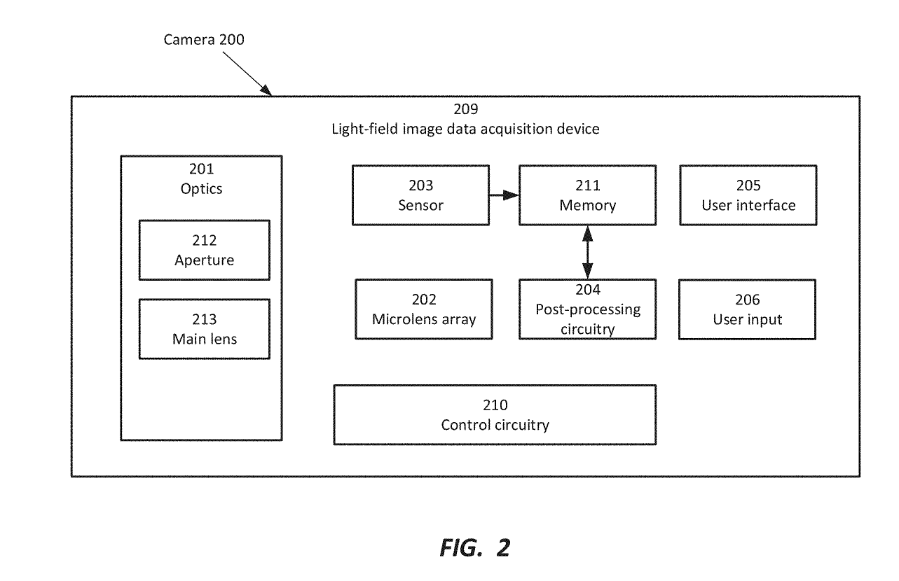

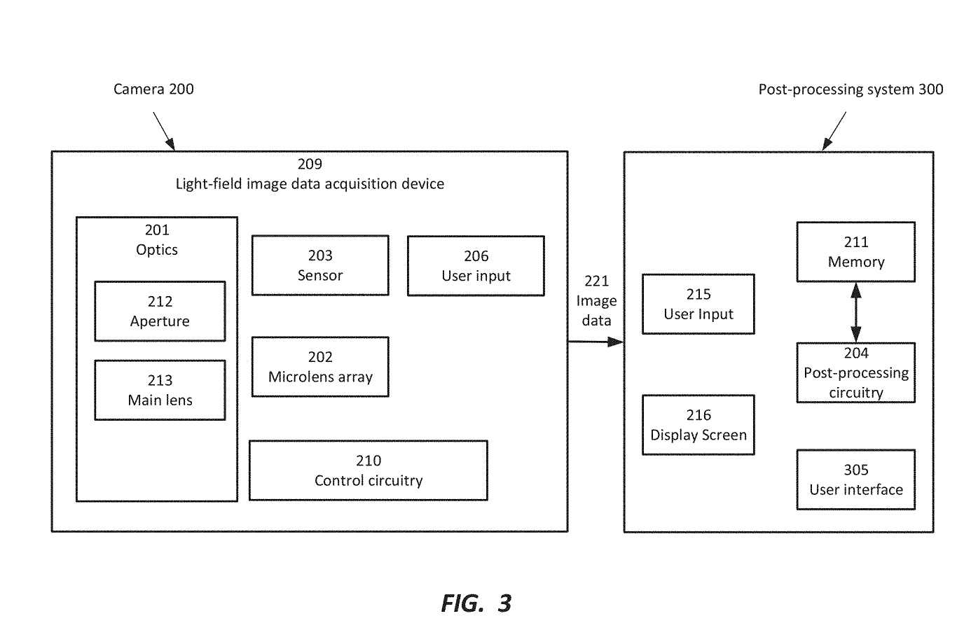

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science. Referring now to FIG. 2, there is shown a block diagram depicting an architecture for implementing the method of the present disclosure in a light-field capture device such as a camera 200. Referring now also to FIG. 3, there is shown a block diagram depicting an architecture for implementing the method of the present disclosure in a post-processing system 300 communicatively coupled to a light-field capture device such as a camera 200, according to one embodiment. One skilled in the art will recognize that the particular configurations shown in FIGS. 2 and 3 are merely exemplary, and that other architectures are possible for camera 200. One skilled in the art will further recognize that several of the components shown in the configurations of FIGS. 2 and 3 are optional, and may be omitted or reconfigured.

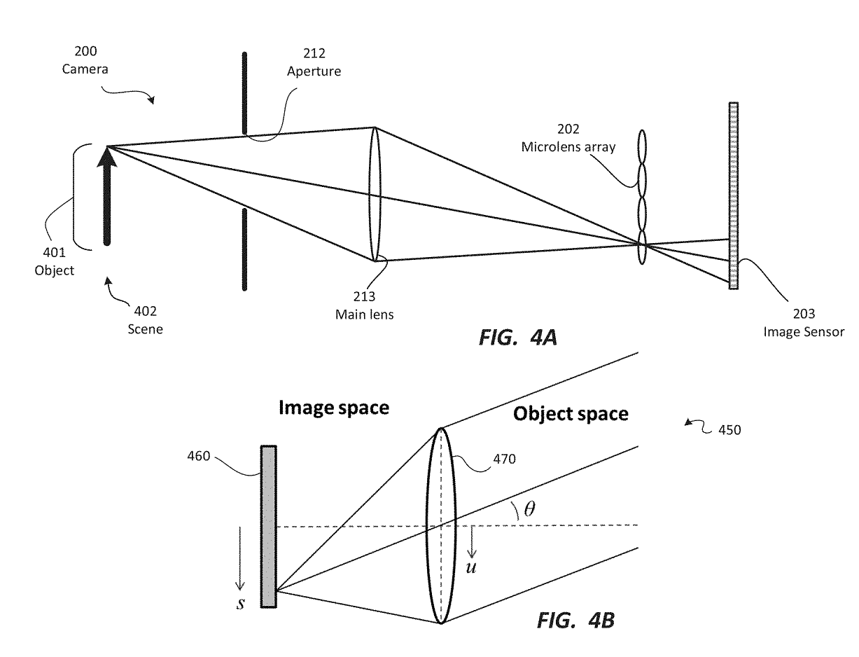

In at least one embodiment, camera 200 may be a light-field camera that includes light-field image data acquisition device 209 having optics 201, image sensor 203 (including a plurality of individual sensors for capturing pixels), and microlens array 202. Optics 201 may include, for example, aperture 212 for allowing a selectable amount of light into camera 200, and main lens 213 for focusing light toward microlens array 202. In at least one embodiment, microlens array 202 may be disposed and/or incorporated in the optical path of camera 200 (between main lens 213 and image sensor 203) so as to facilitate acquisition, capture, sampling of, recording, and/or obtaining light-field image data via image sensor 203. Referring now also to FIG. 4A, there is shown an example of an architecture for a light-field camera, or camera 200, for implementing the method of the present disclosure according to one embodiment. The Figure is not shown to scale. FIG. 4A shows, in conceptual form, the relationship between aperture 212, main lens 213, microlens array 202, and image sensor 203, as such components interact to capture light-field data for one or more objects, represented by an object 401, which may be part of a scene 402.

In at least one embodiment, camera 200 may also include a user interface 205 for allowing a user to provide input for controlling the operation of camera 200 for capturing, acquiring, storing, and/or processing image data. The user interface 205 may receive user input from the user via an input device 206, which may include any one or more user input mechanisms known in the art. For example, the input device 206 may include one or more buttons, switches, touch screens, gesture interpretation devices, pointing devices, and/or the like.

Similarly, in at least one embodiment, post-processing system 300 may include a user interface 305 that allows the user to initiate processing, viewing, and/or other output of light-field images. The user interface 305 may additionally or alternatively facilitate the receipt of user input from the user to establish one or more parameters of subsequent image processing.

In at least one embodiment, camera 200 may also include control circuitry 210 for facilitating acquisition, sampling, recording, and/or obtaining light-field image data. For example, control circuitry 210 may manage and/or control (automatically or in response to user input) the acquisition timing, rate of acquisition, sampling, capturing, recording, and/or obtaining of light-field image data.

In at least one embodiment, camera 200 may include memory 211 for storing image data, such as output by image sensor 203. Such memory 211 can include external and/or internal memory. In at least one embodiment, memory 211 can be provided at a separate device and/or location from camera 200.

For example, camera 200 may store raw light-field image data, as output by image sensor 203, and/or a representation thereof, such as a compressed image data file. In addition, as described in related U.S. Utility application Ser. No. 12/703,367 for “Light-field Camera Image, File and Configuration Data, and Method of Using, Storing and Communicating Same,” (Atty. Docket No. LYT3003), filed Feb. 10, 2010 and incorporated herein by reference in its entirety, memory 211 can also store data representing the characteristics, parameters, and/or configurations (collectively “configuration data”) of device 209. The configuration data may include light-field image capture parameters such as zoom and focus settings.

In at least one embodiment, captured image data is provided to post-processing circuitry 204. The post-processing circuitry 204 may be disposed in or integrated into light-field image data acquisition device 209, as shown in FIG. 2, or it may be in a separate component external to light-field image data acquisition device 209, as shown in FIG. 3. Such separate component may be local or remote with respect to light-field image data acquisition device 209. Any suitable wired or wireless protocol can be used for transmitting image data 221 to circuitry 204; for example, the camera 200 can transmit image data 221 and/or other data via the Internet, a cellular data network, a Wi-Fi network, a Bluetooth communication protocol, and/or any other suitable means.

Such a separate component may include any of a wide variety of computing devices, including but not limited to computers, smartphones, tablets, cameras, and/or any other device that processes digital information. Such a separate component may include additional features such as a user input 215 and/or a display screen 216. If desired, light-field image data may be displayed for the user on the display screen 216.

### Light-Field Imaging Overview

Light-field images often include a plurality of projections (which may be circular or of other shapes) of aperture 212 of camera 200, each projection taken from a different vantage point on the camera's focal plane. The light-field image may be captured on image sensor 203. The interposition of microlens array 202 between main lens 213 and image sensor 203 causes images of aperture 212 to be formed on image sensor 203, each microlens in microlens array 202 projecting a small image of main-lens aperture 212 onto image sensor 203. These aperture-shaped projections are referred to herein as disks, although they need not be circular in shape. The term “disk” is not intended to be limited to a circular region, but can refer to a region of any shape.

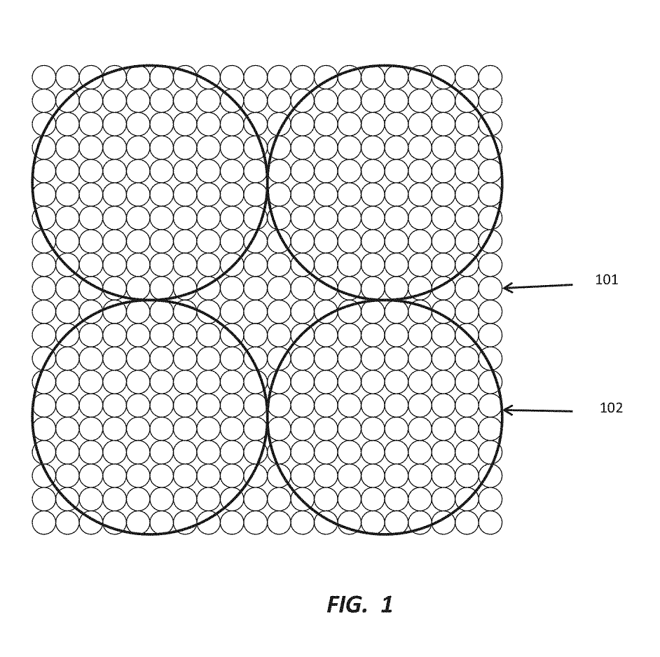

Light-field images include four dimensions of information describing light rays impinging on the focal plane of camera 200 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a 4-D (x,y,u,v) resolution of (400,300,10,10). Referring now to FIG. 1, there is shown an example of a 2-disk by 2-disk portion of such a light-field image, including depictions of disks 102 and individual pixels 101; for illustrative purposes, each disk 102 is ten pixels 101 across.

In at least one embodiment, the 4-D light-field representation may be reduced to a 2-D image through a process of projection and reconstruction. As described in more detail in related U.S. Utility application Ser. No. 13/774,971 for “Compensating for Variation in Microlens Position During Light Field Image Processing,” (Atty. Docket No. LYT021), filed Feb. 22, 2013 and issued on Sep. 9, 2014 as U.S. Pat. No. 8,831,377, the disclosure of which is incorporated herein by reference in its entirety, a virtual surface of projection may be introduced, and the intersections of representative rays with the virtual surface can be computed. The color of each representative ray may be taken to be equal to the color of its corresponding pixel.

Any number of image processing techniques can be used to reduce color artifacts, reduce projection artifacts, increase dynamic range, and/or otherwise improve image quality. Examples of such techniques, including for example modulation, demodulation, and demosaicing, are described in related U.S. application Ser. No. 13/774,925 for “Compensating for Sensor Saturation and Microlens Modulation During Light Field Image Processing” (Atty. Docket No. LYT019), filed Feb. 22, 2013 and issued on Feb. 3, 2015 as U.S. Pat. No. 8,948,545, the disclosure of which is incorporated herein by reference in its entirety.

### Spatial and Angular Dimensions

Referring to FIG. 4B, a diagram 450 depicts the image space and object space applicable to conventional imaging, according to one embodiment. “Spatial dimension” and “angular dimension” can have different or even opposite meanings depending on the context. A conventional (i.e., two-dimensional) camera may along the sensor 460, which in image space is a spatial dimension. However, in object space, this is an angular dimension. In a sense, the main lens 470 maps the angular coordinates (θ) in object space onto the spatial coordinates (s) in image space. Since, in image space, s is a spatial coordinate, it is also often referred to as x. The corresponding planar coordinate is t (or y).

A light-field camera, in addition to sampling in st, also samples in uv. For a plenoptic camera, sampling in uv may entail sampling within each microlens, which may optically correspond to positions on the main lens. In object space, this may act as a spatial coordinate, whereas in image space this is an angular coordinate.

Similarly, for a camera array, the uv coordinates may correspond to different physical camera. The physical cameras may be spatially displaced from each other in an array.

In a generic two-plane parameterization of a light-field imaging system, neither st nor uv is truly angular or spatial. The most precise terminology would use solely st and uv to refer to the mathematics of the system. However, within this disclosure, st will be referred to as “spatial” and uv will be referred to as “angular” to ease interpretation.

In this sense, a conventional camera samples in the st (spatial) domain, and a light-field camera additionally samples in the uv (angular) domain. Imaging “resolution” also typically refers to resolution in the st plane, since this corresponds to resolvability for a conventional camera.

### High Dynamic Range Light-Field Image Capture Process

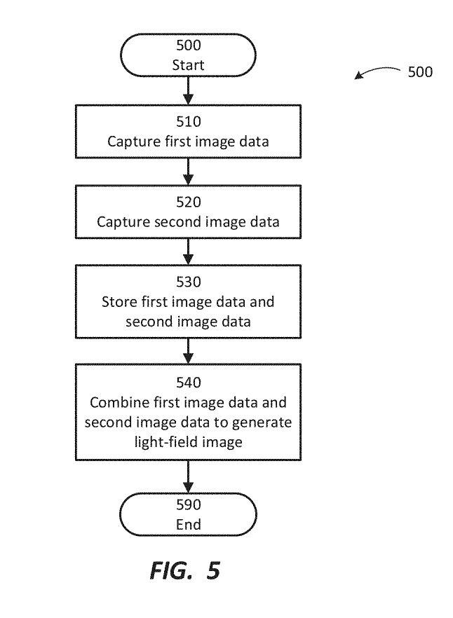

In order to overcome the problems referenced above with high dynamic range imaging in conventional cameras, light-field cameras may be made to carry out high dynamic range imaging, as depicted in FIG. 5. A light-field imaging system may include one or more light-field cameras such as the camera 200 of FIG. 2. The light-field imaging system may start 500 with a step 510 in which image data is captured at a first exposure level. In a step 520, image data may be captured at a second exposure level different from the first exposure level. In a step 530, the first image data and the second image data may be stored in a data store, such as in the memory 211 of the camera 200 of FIG. 2 and/or the memory 211 of the post-processing system 300 of FIG. 3. In a step 540, a processor, such as the post-processing circuitry 204 of the camera 200 and/or the post-processing circuitry 204 of the post-processing system 300 of FIG. 3, may combine the first image data and the second image data into a single light-field image, which may be a high dynamic range (HDR) light-field image due to the presence of image data captured at the two disparate exposure levels. The method may then end 590. Light-field camera architecture may provide many options for how the method of FIG. 5 may be accomplished, as will be described in detail subsequently.

### Limitations of Conventional High Dynamic Range Imaging

In some embodiments, different portions of a sensor may be driven at different exposure levels, potentially allowing for the capture of HDR light-field images with a single light-field camera having single sensor. To produce color HDR images, both “color differentiation” and “exposure differentiation” must be performed.

Color differentiation may be performed optically using any of a variety of optical color differentiation elements such as color filters (for example, Bayer filters, trichroic prisms, and/or the like). Additionally or alternatively, color differentiation may be done electronically with any of a variety of electronic color differentiation elements (for example, with foveon ×3, solid-state tunable filters, and/or the like). Additionally or alternatively, color differentiation may be done acoustically with an acoustic color differentiation element (for example, with acousto-optic tunable filters and/or the like).

Exposure differentiation can be performed optically through the use of any of a variety of optical exposure differentiation elements (for example, with an ND filter). Additionally or alternatively, exposure differentiation may be done electronically through the use of an electronic exposure differentiation element (for example, with exposure or gain control). Electronic exposure differentiation has the advantage of avoiding the degradation in image quality that can occur as light is filtered out from the optical pathway.

A conventional two-dimensional camera samples a scene only in the spatial coordinates. Accordingly, both color differentiation and exposure differentiation must be done spatially. Consequently, in simple implementations, exposure differentiation and color differentiation may interfere with each other, leading to a reduction in the spatial resolution of the imaging system.

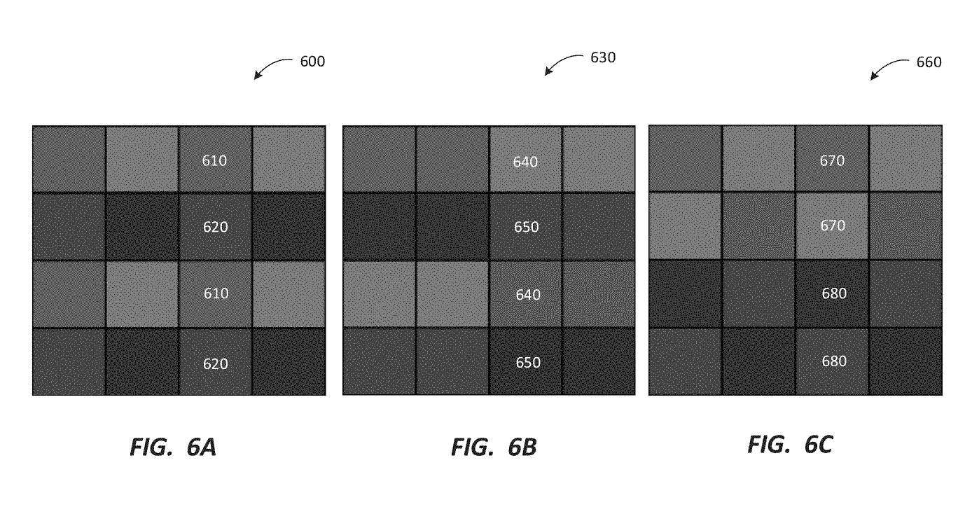

Referring to FIGS. 6A through 6C, various patterns depict different options for providing color and exposure differentiation on the sensor, according to certain embodiments. Specifically, FIG. 6A depicts a pattern 600, FIG. 6B depicts a pattern 630, and FIG. 6C depicts a pattern 660.

In FIG. 6A, the pattern 600 is a standard Bayer pattern in which alternating columns are overexposed and underexposed. Specifically, the rows 610 are overexposed while the rows 620 are underexposed. The green channel is evenly sampled in both exposures because it is equally present in the rows 610 that are overexposed and in the rows 620 that are underexposed. However, all blue samples are in the rows 620, and therefore are all underexposed. Similarly, all red samples are in the rows 610, and therefore are all overexposed. This color bias could lead to color artifacts at either end of the dynamic range.

In FIG. 6B, the pattern 630 is a Bayer pattern that has been upscaled by a factor of two while keeping the exposure pattern. The rows 640 may be overexposed, while the rows 650 may be underexposed. This may allow all colors to have both exposure samples. However, the pattern 630 may also reduce the spatial resolution of the captured image by a factor of two.

In FIG. 6C, the pattern 660 is a standard Bayer pattern that is used with alternating pairs of rows. Specifically, the rows 670 may be overexposed, while the rows 680 may be underexposed. This arrangement may also allow all colors to have both exposure samples, but as in the pattern 630 of FIG. 6B, may cause the resulting image to have a spatial resolution that is reduced by a factor of two.

Light-field imaging may present a much more flexible framework for HDR imaging. This is because exposure differentiation and color differentiation can be performed in either of the st and uv domains. Thus, many more options for exposure differentiation and/or color differentiation may be available in light-field imaging systems.

High Dynamic Range Imaging with Plenoptic Light-Field Cameras

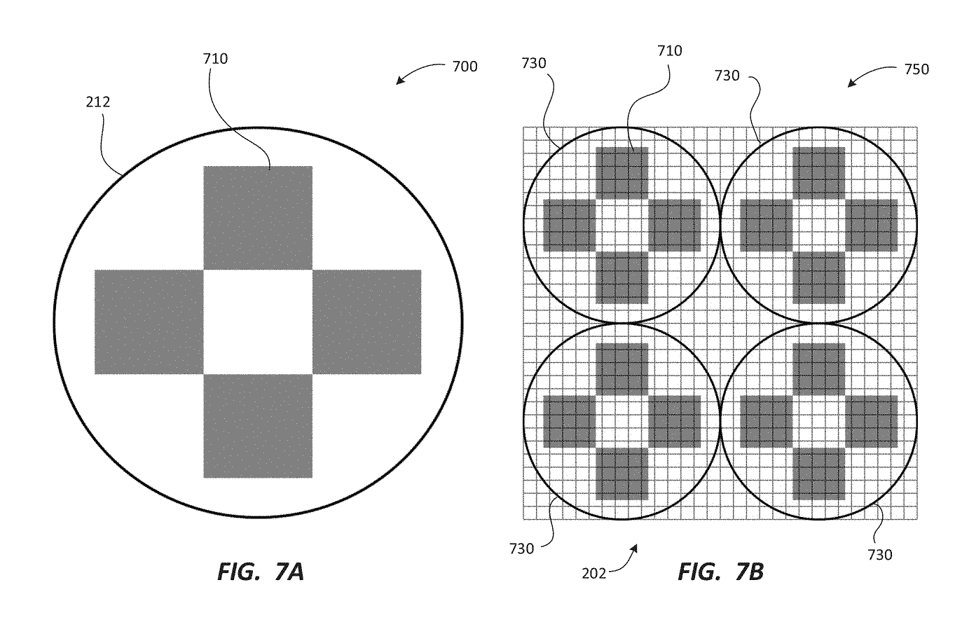

In a plenoptic light-field camera, such as the camera 200 of FIG. 2, the sensor samples the uv domain, while the microlenses sample the st domain. By comparison, a conventional camera samples the st domain on the sensor. This means that applying color or exposure differentiation on the sensor in a plenoptic light-field camera is equivalent to sampling in uv domain. Furthermore, since each microlens images the main aperture, applying a filter pattern on the main aperture is equivalent to applying that same pattern on all microlenses. Thus uv sampling can also be performed by modifying the main aperture, as depicted in FIGS. 7A and 7B.

Referring to FIGS. 7A and 7B, diagrams 700, 750, respectively, depict the use of a non-uniform pattern filter 710, which may be an ND filter, color filter, and/or the like, according to one embodiment. In FIG. 7A, the non-uniform pattern filter 710 is applied to the aperture 212 of a plenoptic light-field camera such as the camera 200 of FIG. 2. The non-uniform pattern filter 710 will be imaged by all microlenses of the microlens array 202, producing the same pattern across the entire sensor 203. In FIG. 7B, the non-uniform pattern filter 710 is applied individually to each microlens 730 in a microlens array 202. In either case, the result may be exposure differentiation in the uv domain.

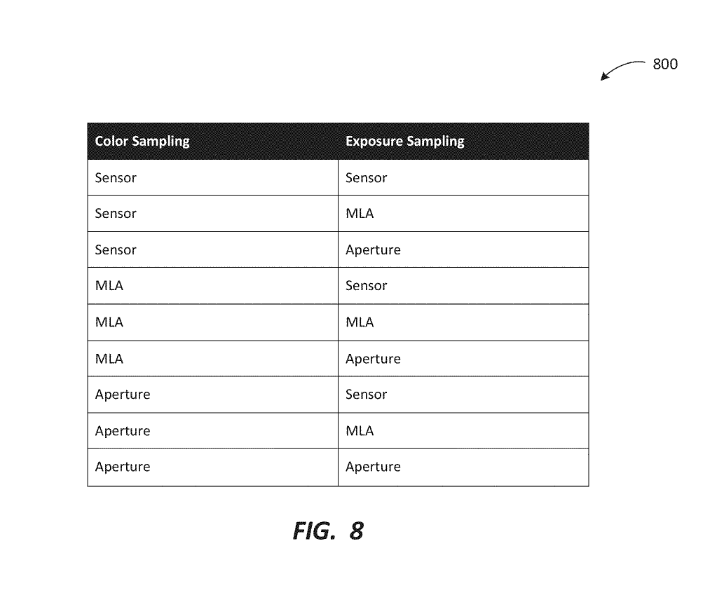

In a plenoptic light-field camera, exposure differentiation and color differentiation can each occur at three possible locations: at the sensor, at the microlens array, and at the aperture. This results in nine possible combinations, which are summarized in a table 800 in FIG. 8. All three locations allow sampling in uv, whereas only the microlens array allows sampling in st. Two solutions, sensor-sensor and microlens array-sensor, will be discussed in depth, while the remaining solutions will be outlined.

### Sensor-Sensor

This is the most basic solution and can be applied to conventional imaging as well. In a conventional camera, the sensor samples st, whereas in a plenoptic camera the sensor samples uv (technically stuv since the uv sampling may change with st due to alignment). Thus, a conventional camera will lose resolution, but a plenoptic camera may only have minimal resolution loss.

Care must be taken to avoid sampling patterns that will cause exposure differentiation and color differentiation to interfere, as in the pattern 600 of FIG. 6A. The pattern 630 of FIG. 6B may function well for a light-field camera that carries out both exposure differentiation and color differentiation at the sensor. A standard debayering algorithm may be used on 2×2 pixel groups. This may accomplish creation of a color image. While image resolution is minimally reduced, the reduction of uv resolution may result in a smaller refocusable change. The example 660 of FIG. 6C may also function well for a light-field camera that carries out both exposure differentiation and color differentiation at the sensor, and may only require a standard debayering.

To create an HDR image, the underexposed pixels may be normalized so that their values are what they would be had the pixels not been underexposed. This can be accomplished by scaling those pixels by the ratio of exposures. The following formula, for example, may be used:

$${p}_{norm} = {p}_{underexposed} \times \frac{{exposure}_{high}}{{exposure}_{low}}$$

Background subtraction may advantageously be performed before normalizing, if possible. In this equation, P_{underexposed} is the pixel value of the underexposed pixel after background subtraction.

As an alternative, if the camera is to be used only in HDR mode, the appropriate scaling values can be precomputed as part of calibration. A common calibration used in plenoptic cameras is a demodulation calibration, which accounts for natural variations in brightness in the microlenses. Such natural variation, coupled with the compensating calibration, may result in a small amount of naturally-occurring high dynamic range capability. If the exposure differentiation is enabled during calibration, the exposure differentiation may be “baked into” the demodulation calibration so that applying the demodulation calibration will automatically normalize the underexposed pixels.

Once the underexposed pixels have been normalized, the saturated pixels of the overexposed pixels and/or the dark pixels of the underexposed pixels may be removed and/or de-weighted. Consequently, every remaining pixel in the four-dimensional light-field may contain valid data across the extended dynamic range. Total saturation may not occur until the underexposed pixels are saturated, and total black may not occur until the overexposed pixels are black.

The four-dimensional light-field may be collapsed into a two-dimensional image via projection, as set forth in the related applications cited previously, or via other methods. A high dynamic range two-dimensional image may be generated by this process because every sample in the two-dimensional output is the average of multiple pixels in light-field. Even if half of the data is missing for that two-dimensional sample due to saturation, a valid value can still be obtained.

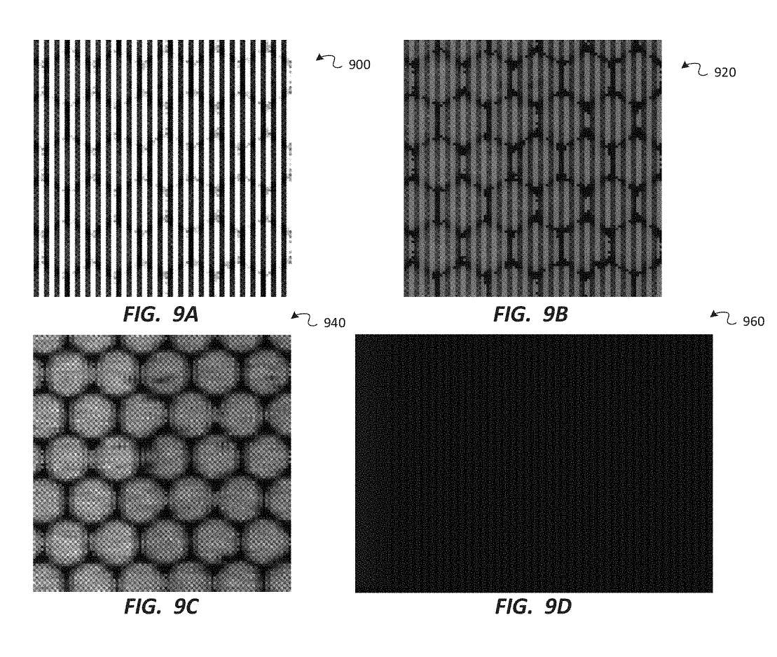

Referring to FIGS. 9A through 9D, diagrams 900, 920, 940, and 960, respectively, depict processing steps in the generation of a high dynamic range light-field image, according to one embodiment. In FIG. 9A, the diagram 900 depicts raw high dynamic range image capture using exposure differentiation on column pairs of a sensor. In FIG. 9B, the diagram 920 depicts the identification and masking out of saturated and dark pixels. The underexposed columns may be normalized so that they have the same effective exposure as the overexposed columns. In FIG. 9C, the diagram 940 depicts a step in which the pixels masked out in the previous step are inpainted to avoid debayering artifacts. Those pixels may be masked out again before projection in to a two-dimensional image. In FIG. 9D, the diagram 960 depicts the results of projection of the high dynamic range light-field.

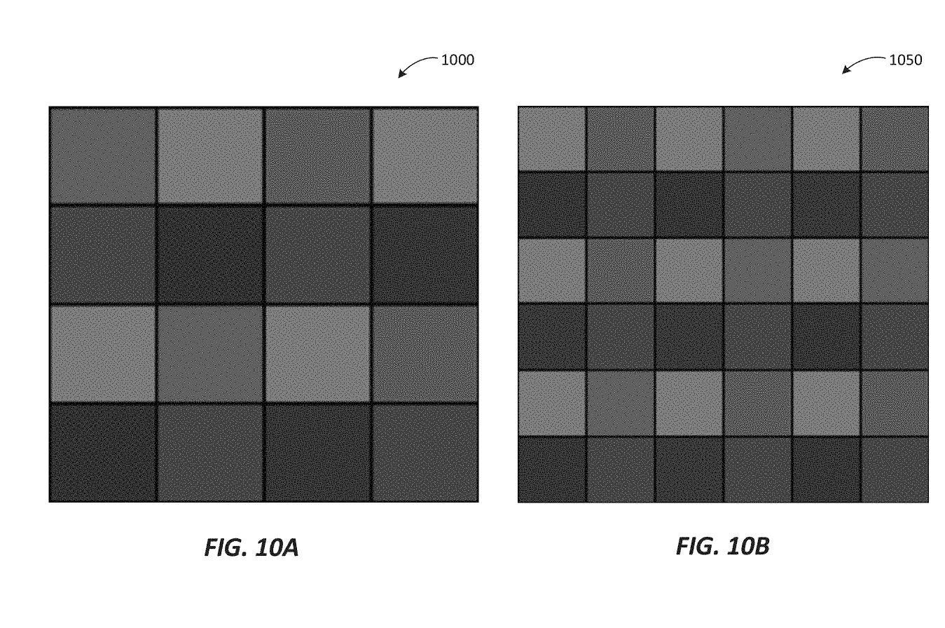

In other embodiments, alternative color filter patterns can also be used. Such alternative color filter patterns may help reduce artifacts, facilitate processing, and/or provide other advantages. Exemplary alternative filter patterns will be shown and described in connection with FIGS. 10A and 10B.

Referring to FIGS. 10A and 10B, filter patterns 1000, 1050, respectively, may be used in alternative embodiments. The filter pattern 1000 is a 4×4 pattern, and the filter pattern 1050 is a 6×6 pattern. Both patterns may reduce clustering of exposure and color differentiation, potentially reducing artifacts in the projected two-dimensional image.

The filter pattern 1000 may be simpler than the filter pattern 1050, and may be broken up into 2×2 Bayer patterns so it may be easier to demosaic. Nevertheless, such demosaicing may need to account for the exposure differentiation.

The filter pattern 1050 may be more complicated to demosaic than the filter pattern 1000. Further, in the filter pattern 1050, the blue channel has more overexposed pixels than underexposed, and vice versa for red. In alternative embodiments, this property can be reversed. This color exposure imbalance may compensate somewhat for transmissivity differences between color channels. Specifically, blue may be much less transmissive than the other channels, so a comparative overexposure of the blue channel may help balance out this transmissivity difference.

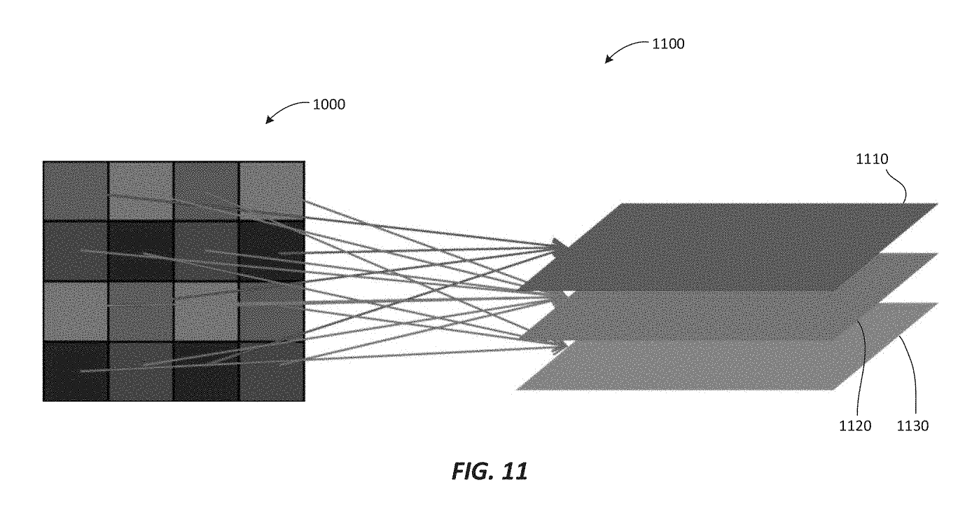

Referring to FIG. 11, a diagram 1100 depicts the direct projection of a red color channel 1110, a green color channel 1120, and a blue color channel 1130 from the filter pattern 1000 of FIG. 10A, according to one embodiment. In some embodiments, such as those utilizing the filter pattern 1000 or the filter pattern 1050, demosaicing may not be performed. Rather, color can be reconstructed by projecting each channel independently directly from the raw image. The red pixels may only be projected into the red channel of the output, the green into the green, and the blue into the blue. This may be similar to the manner in which high dynamic range is obtained, since there may be multiple samples per two-dimensional pixel. Since the samples are not clustered, no holes should appear the output and colors should be correct. Minor hole filling might be needed in corner cases; this can be accomplished using known methods.

### MLA-Sensor

According to one embodiment, the Bayer pattern may be applied to the microlens array (such as the microlens array 202 of FIG. 2) or “MLA,” leaving a monochrome sensor with alternating exposure rows (not shown). Thus, color differentiation may be carried out at the microlens array, while exposure differentiation may be carried out at the sensor.

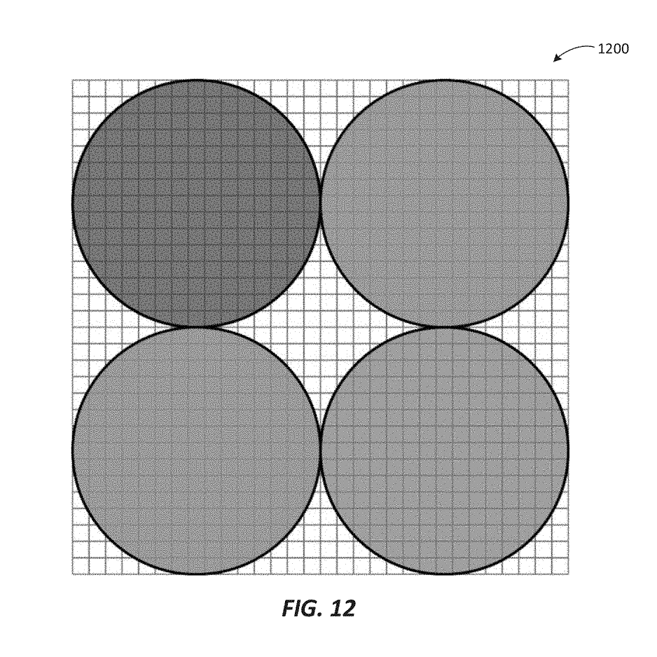

Referring to FIG. 12, a diagram 1200 depicts application of a Bayer pattern to a microlens array, according to one embodiment. In such a case, debayering may be applied to the microlens array. A sensor-level debayering algorithm such as a standard debayer may be thought of as interpolating the RGB values for each stuv coordinate from the neighboring uv samples at the same st. Debayering at the microlens may interpolate RGB values for each stuv from neighboring st samples at the same uv. Although more complicated than sensor-level debayering, a standard debayering algorithm can be adapted to perform such a task.

Alternatively, the light-field can be resampled such that neighboring pixels change in st rather than uv. The resulting image is colloquially known as a subaperture grid or view array, which is a grid of st images (i.e. subaperture images or views), with adjacent images having adjacent uv coordinates. The subaperture grid, if properly resampled, may have a pixel-level Bayer pattern that can be debayered the normal way (for example, using an algorithm ordinarily used to debayer an image that has been captured with a sensor-level Bayer pattern).

Once the full RGB light-field is formed, the high dynamic range light-field image and high dynamic range two-dimensional projected image(s) can be formed in the same way as the sensor-sensor method. The underexposed pixels may be normalized and the saturated and dark pixels may be removed to generate the high dynamic range light-field image, as shown and described in connection with FIGS. 9A through 9D. The HDR light-field image may be collapsed to a two-dimensional image. The resulting image may be a high dynamic range two-dimensional image.

The per-channel projection technique shown and described in connection with FIG. 11 may additionally or alternatively be used. However, due to the possible presence of large clusters of color differentiation (on the sensor coordinates), this type of projection may result in holes in the final image. Accordingly, it may be advantageous to apply a debayering technique rather than directly projecting the color channels in this manner.

Color differentiation at the microlens array can also use a color pattern on each microlens. However, this method may require significant calibration, since the color boundaries may not line up with photosite boundaries. Accordingly, some pixels may record multiple colors.

### Sensor-MLA

According to another embodiment, color differentiation may be carried out at a sensor, such as the sensor 203 of the camera 200 of FIG. 2, by applying a standard Bayer filter at the sensor. Exposure differentiation may be carried out at a microlens array, such as the microlens array 202 of the camera of FIG. 2, by applying a patterned ND filter at the microlens array. Each microlens may have an ND pattern.

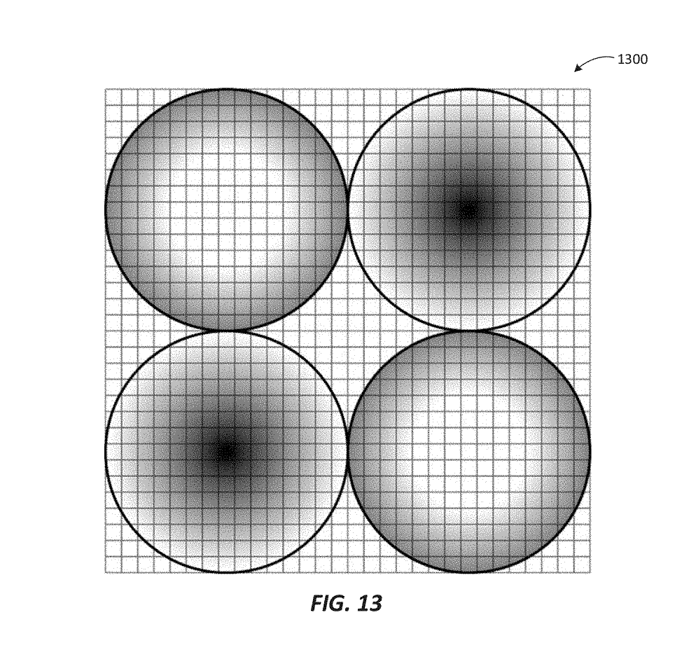

In some embodiments, the ND pattern can be uniform within each microlens and differ across microlenses. In such a case, exposure differentiation may occur in st. The ND pattern can also be the identical across microlenses, but have a complex pattern within each microlens, as in FIG. 7A. In such a case, exposure differentiation may occur in uv. A combination pattern that varies within each microlens and across microlenses can also be used. One such pattern will be shown and described in connection with FIG. 13.

Referring to FIG. 13, a patterned ND filter 1300 is depicted, applied to a microlens array, according to one embodiment. With the patterned ND filter 1300, exposure differentiation may occur in both uv and st.

One potential issue that may result from sampling purely in the uv domain is that if all microlenses in the microlens array have identical patterns, the pattern may be visible in out-of-focus areas in a refocused image. This can be mitigated by changing the uv sampling pattern across microlenses.

To produce a color image, a standard Bayer algorithm may be used. To produce a high dynamic range light-field image, the same process of normalizing exposures and removing saturated and dark pixels can be used, as set forth in connection with FIGS. 9A through 9D. This process may be somewhat more complex than in embodiments in which the sensor us used for exposure differentiation. In the case of st sampling, resolution may be reduced because the clustering of exposure samples can produce holes in the images that need to be filled in.

In the case of uv sampling, the exposure samples may not necessarily be at discrete exposure levels due to either misalignment (as in FIG. 7A) or the use of a continuous (for example, gradient-based) ND pattern (as in FIG. 13). This may make it more challenging to determine which saturated pixels to remove and which dark pixels to remove. For embodiments in which exposure differentiation is carried out at the sensor, it is clear which pixels are overexposed and which pixels are underexposed, making it relatively simple to remove oversaturated and dark pixels. However, where the exposure differentiation has more than two gradations, identification of saturated and/or dark pixels can be more challenging.

Accordingly, carrying out exposure differentiation at the microlens array may lead to the need for more complex processing. Further, use of the ND filter may have an adverse effect on image quality due to the reduction in the overall quantity of light received by the sensor.

### MLA-MLA

In some embodiments, both color differentiation and exposure differentiation may be carried out at the microlens array. This may be done, for example, by combining FIG. 12 and FIG. 13. The color differentiation and exposure differentiation can both be in st coordinates, which may result in a large resolution penalty.

In the alternative to the foregoing, it may be advantageous to perform color differentiation in st (as in FIG. 12) and exposure differentiation in uv (as in FIG. 7A) or stuv (as in FIG. 13). In this case, debayering may be carried out in a manner similar to that of the MLA-sensor case. Reconstruction of the high dynamic range light-field image and/or projection of the two-dimensional high dynamic range image may be carried out in a manner similar to that of the sensor-MLA case.

As another alternative, both color differentiation and exposure differentiation may be performed in uv or in stuv. This approach may present additional calibration challenges, as color differentiation would not necessarily be discrete due to boundary alignment issues like those set forth in the description of the MLA-sensor approach.

### Sensor-Aperture and MLA-Aperture

In other embodiments, color differentiation may be carried out at the sensor or at the microlens array, while exposure differentiation is carried out at an aperture, such as the aperture 212 of FIG. 4. Since each microlens images the aperture, applying a pattern on the aperture may be equivalent to applying the same pattern on each of the microlenses, as depicted in FIGS. 7A and 7B). Thus, the image data captured in these embodiments may be processed in ways similar to those of the sensor-MLA and the MLA-MLA cases, as set forth previously.

With exposure differentiation at the aperture, since all microlenses are identically patterned, stuv sampling may not be feasible. Accordingly, the sampling pattern (for example, an ND filter or the like) applied to the aperture may appear as an artifact in out-of-focus regions of the resulting high dynamic range images. Incidentally, lens vignetting and/or shading may intrinsically cause some amount of exposure differentiation on the aperture.

### Aperture-Sensor, Aperture-MLA, and Aperture-Aperture

In some embodiments, color differentiation may be carried out at the aperture, while exposure differentiation is carried out at the aperture, at the microlens array, and/or at the sensor. Since each microlens images the aperture, application of any pattern on the aperture may be equivalent to applying the same pattern on each of the microlenses, as in FIGS. 7A and 7B. Image data captured in these embodiments may thus be processed with approaches similar to those of the MLA-sensor and MLA-MLA cases, as set forth previously. As discussed above, color differentiation in uv using the microlenses may be challenging due to potential overlap of pixels with color boundaries.

### Camera Arrays

Another common light-field imaging system is a camera array, in which a plurality of conventional and/or light-field cameras are used to capture a four-dimensional light-field. In some embodiments, conventional cameras may be used; the array of cameras may functionally take the place of the microlens array of a plenoptic light-field camera.

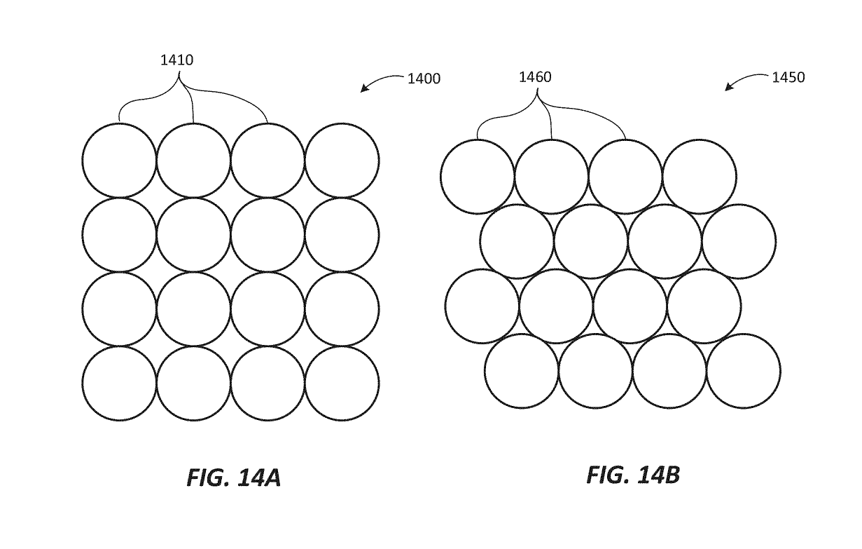

Referring to FIGS. 14A and 14B, diagrams depict light-field imaging systems in the form of a camera array 1400 and a camera array 1450, according to certain embodiments. In FIG. 14A, the camera array 1400 may have a plurality of cameras 1410 arranged in a grid pattern, defining a Cartesian pattern. In FIG. 14B, the camera array 1450 may have a plurality of cameras 1460 arranged in a hexagonal pattern.

In a camera array, the sensor of each camera may sample st, and each individual camera may sample a uv coordinate. The sensor-sensor solution may then become equivalent to a conventional high dynamic range camera in that both exposure and color differentiation occur in the st domain.

To sample in the uv domain, color filters can be used on each camera for color differentiation. Different cameras may be set to different exposures for exposure differentiation. This can create a very flexible high dynamic range camera system if the cameras used are all monochrome, since the color differentiation and exposure differentiation can be easily changed by changing out color filters or changing exposure settings. Using a monochrome sensor may also maximize image resolution.

In addition, while the sensor samples in the st domain, different cameras can sample the st domain differently, creating a combined stuv sampling pattern. An example of this would be if all cameras used a standard Bayer pattern and had alternating exposure rows as in FIG. 6A, but neighboring cameras were flipped in the exposure pattern (i.e. the starting row exposure alternates across cameras). Whereas each individual camera may have issues with interference between exposure differentiation and color differentiation, the light-field as a whole may be largely unaffected by such interference.

### Temporal High Dynamic Range Sampling Approaches

In addition to st, uv and stuv sampling, it is possible to introduce temporal sampling to further increase dynamic range, flexibility and accuracy of the process. Temporal sampling may introduce variation in the time at which various portions of the image data are captured. If the capture times are close enough together, the scene being imaged will not have changed significantly between the capture times. Exposure differentiation may be applied between capture times so that the exposure level changes from one capture to the next.

The domains for temporally sequential sampling can exist at the electronics readout and/or at the optics transmission level. It is possible to either provide the ability to increase or decrease the exposure or gain of a given pixel row, column, and/or region to provide exposure variation in synchronization with the frame rate of acquisition. It is additionally possible to introduce an additional transmissive and/or polarized display technology within the optical path to globally or regionally alter light transmission in synchronization with the frame rate of acquisition.

These two approaches (electronic exposure differentiation and transmissive exposure differentiation) may additionally be leveraged independently or together, and may further be matrixed with any of the above-described single frame approaches. Therefore, there are three color, three exposure, and three temporal sampling techniques (electronic, transmissive, and electronic and transmissive together), resulting in twenty-seven potential methods when combining temporal and single frame HDR acquisition methodologies as outlined below.

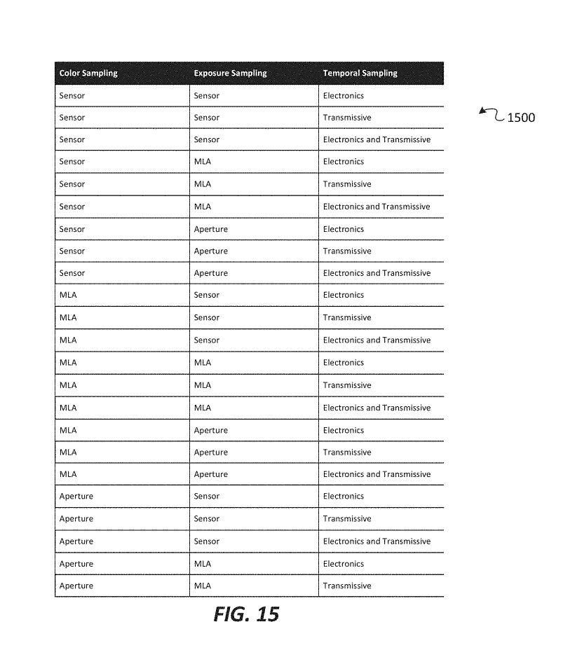

Referring to FIG. 15, a chart 1500 depicts these twenty-seven combinations. Exemplary applications of electronic exposure differentiation and transmissive exposure differentiation will be described in greater detail below.

### Electronically-Controlled Temporally-Sequenced Exposure

It is possible to program the electronics of an imaging sensor to read out repeating temporal patterns of exposure. For example, leveraging the sensor/sensor approach, the readout may be programmed as follows:
Frame N: Region y(A): Exp₁, Region y(B): Exp₂, etc.
Frame N+X: Region y(A): Exp₃, Region y(B): Exp₄, etc.
Frame N+X+Y: Region y(A): Exp₅, Region y(B): Exp₆, etc.

In the foregoing, each exposure may be the same or different values. The number of frames may be one or more frame in a temporal sequence and may or may not be linearly ordered. The number of exposure values varied spatially may include two or more values.

A simplistic approach may be applied by normalizing the values as previously described in connection with FIGS. 9A through 9D. Single-frame high dynamic range image processing may be used. Sequential exposures may be blended as identified above. However, due to the temporal difference between the captured imagery (moving object, moving camera, motion blur, etc.), temporal artifacts may be problematic, and may result in blurred and/or artifacted imagery. With sufficiently high temporal sampling frame rates and/or sufficiently low exposure times, motion blur may be mitigated if not eliminated.

Further, through the introduction of optical flow vectors from the light-field imaging data, it is possible to retarget objects toward a center temporal frame and further increase the accuracy of the dynamic range by averaging the usable portions of the adjacent frames with the alternating exposure information. Regions with low confidence may be de-weighted or eliminated from the final output pixel. For example, once frames N−X_{Y} and N+X_{Y} have an accurate flow analysis of pixel translation between the N and N frames, the normalized pixels contained within the light-field may be projected to the location corresponding to the N−X−Y to N frame or N+X+Y to N frame.

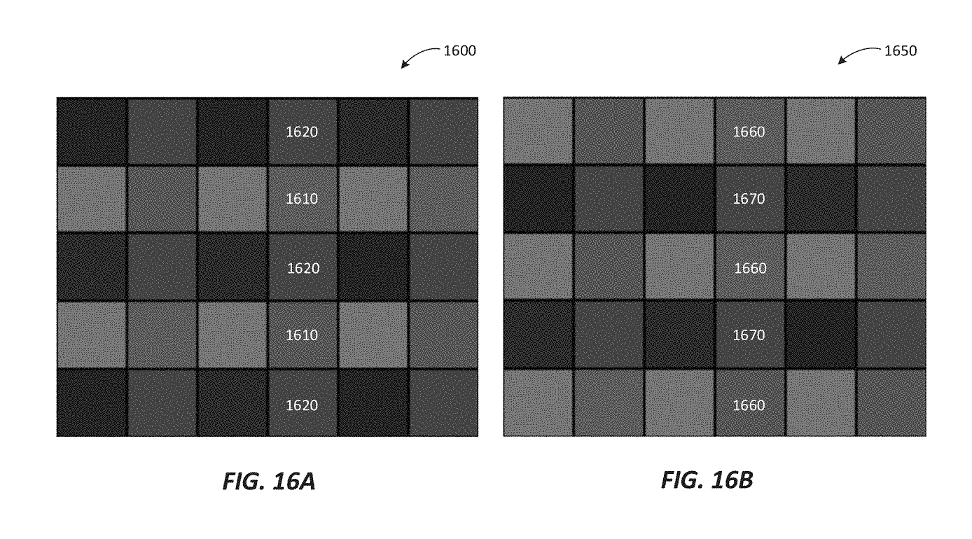

Referring to FIGS. 16A and 16B, a pattern 1600 and a pattern 1650 depict exemplary electronically-controlled, sequential exposure configuration patterns, according to one embodiment. In FIG. 16A, the pattern 1600 shows frame N, referenced above, with high exposure rows 1610 and low exposure rows 1620. In FIG. 16B, the pattern 1650 shows frame N+XY, with high exposure rows 1660 and low exposure rows 1670.

With this approach, the resulting exposure can be expressed as the average sampled result per xy two-dimensional pixel coordinate for frame N for all temporal pixels for that specified output coordinate. This may result in the ability to further increase the dynamic range by temporally increasing the exposure range in shadow and/or highlight details. This may provide the ability to intentionally oversaturate these portions of the image to provide proper exposure for extremely low illumination levels. This intentional oversaturation may be obtained without compromising regions within a single sampled frame, which may contain fewer potential samples due to oversaturation or underexposure.

### Transmissive Display-Controlled Temporally-Sequenced Exposure

A second method of temporal sampling includes the variation of transmissivity of the optical pathway of the camera. Sequentially varying filters may be used in front of the imaging plane. Such sequentially varying filters may exist anywhere within the optical path between the lens and image sensor.

With polarization and transparent display technologies, it is possible to sequentially alter the quantity of light allowed to pass through the display material at extremely high frame rates. The latest generation of transparent OLED displays may allow passage of a variable proportion of light, from about 0% to about 90% of light received by the OLED display. Future generations of the technology may further increase refresh, transmission and/or pixel density of these panels.

In the most simplistic form, this sequentially varying filter may exist as a single global ‘pixel’ that simply switches states of transmission in synchronization with the imaging electronics. In the more complex form, the sequentially varying filter may have a denser pixel structure that corresponds to a known sampling pattern at the pixel level of the image plane. Thus, the sequentially varying filter may provide the ability to vary the transmission by localized region over time.

This sequentially varying exposure information may be projected in the same fashion as identified in the above discussion leveraging optical flow techniques. Thus, a high dynamic range light-field image may be captured, and one or more high dynamic range two-dimensional images may be projected from the high dynamic range light-field image.

The above description and referenced drawings set forth particular details with respect to possible embodiments. Those of skill in the art will appreciate that the techniques described herein may be practiced in other embodiments. First, the particular naming of the components, capitalization of terms, the attributes, data structures, or any other programming or structural aspect is not mandatory or significant, and the mechanisms that implement the techniques described herein may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some embodiments may include a system or a method for performing the above-described techniques, either singly or in any combination. Other embodiments may include a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions of described herein can be embodied in software, firmware and/or hardware, and when embodied in software, can be downloaded to reside on and be operated from different platforms used by a variety of operating systems.

Some embodiments relate to an apparatus for performing the operations described herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), and/or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the techniques set forth herein are not described with reference to any particular programming language. It will be appreciated that a variety of programming languages may be used to implement the techniques described herein, and any references above to specific languages are provided for illustrative purposes only.

Accordingly, in various embodiments, the techniques described herein can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the techniques described herein include: a mobile phone, personal digital assistant, smartphone, kiosk, server computer, enterprise computing device, desktop computer, laptop computer, tablet computer, consumer electronic device, television, set-top box, or the like. An electronic device for implementing the techniques described herein may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

In various embodiments, the techniques described herein can be implemented in a distributed processing environment, networked computing environment, or web-based computing environment. Elements can be implemented on client computing devices, servers, routers, and/or other network or non-network components. In some embodiments, the techniques described herein are implemented using a client/server architecture, wherein some components are implemented on one or more client computing devices and other components are implemented on one or more servers. In one embodiment, in the course of implementing the techniques of the present disclosure, client(s) request content from server(s), and server(s) return content in response to the requests. A browser may be installed at the client computing device for enabling such requests and responses, and for providing a user interface by which the user can initiate and control such interactions and view the presented content.

Any or all of the network components for implementing the described technology may, in some embodiments, be communicatively coupled with one another using any suitable electronic network, whether wired or wireless or any combination thereof, and using any suitable protocols for enabling such communication. One example of such a network is the Internet, although the techniques described herein can be implemented using other networks as well.

While a limited number of embodiments has been described herein, those skilled in the art, having benefit of the above description, will appreciate that other embodiments may be devised which do not depart from the scope of the claims. In addition, it should be noted that the language used in the specification has been principally selected for readability and instructional purposes, and may not have been selected to delineate or circumscribe the inventive subject matter. Accordingly, the disclosure is intended to be illustrative, but not limiting.

What is claimed is:

1. A method for capturing a light-field image, the method comprising:
in a first sensor of a light-field imaging system, capturing first image data at a first exposure level;
in an element selected from the group consisting of the first sensor and a second sensor of the light-field imaging system, capturing second image data at a second exposure level different from the first exposure level;
in a data store, receiving the first image data and the second image data; and
in a processor, combining the first image data and the second image data to generate a light-field image.

2. The method of claim 1, wherein:
the element comprises the first sensor; and
the light-field imaging system comprises a plenoptic light-field camera comprising the first sensor, an aperture through which light enters the plenoptic light-field camera, and a microlens array positioned to direct the light onto the first sensor.

3. The method of claim 2, wherein the plenoptic light-field camera is configured to carry out color differentiation through use of one or more color differentiation elements positioned at the first sensor.

4. The method of claim 2, wherein the plenoptic light-field camera is configured to carry out color differentiation through use of one or more color differentiation elements positioned at the aperture.

5. The method of claim 2, wherein the plenoptic light-field camera is configured to carry out color differentiation through use of one or more color differentiation elements positioned at the microlens array.

6. The method of claim 2, wherein the plenoptic light-field camera is configured to carry out exposure differentiation through use of one or more exposure differentiation elements positioned at the first sensor.

7. The method of claim 2, wherein the plenoptic light-field camera is configured to carry out exposure differentiation through use of one or more exposure differentiation elements positioned at the aperture.

8. The method of claim 2, wherein the plenoptic light-field camera is configured to carry out exposure differentiation through use of one or more exposure differentiation elements positioned at the microlens array.

9. The method of claim 1, wherein:
the light-field imaging system comprises a camera array comprising a plurality of cameras comprising at least a first camera having the first sensor and a second camera having a second sensor; and
the element comprises the second sensor.

10. The method of claim 9, wherein the second camera has a second exposure setting different from a first exposure setting of the first camera.

11. The method of claim 1, wherein:
the light-field imaging system comprises at least a first camera comprising the first sensor;
the element comprises the first sensor;
capturing the second image data comprises capturing the second image data non-simultaneously with capture of the first image data; and
the method further comprises changing a first camera exposure level of the first camera after capture of one of the first image data and the second image data, and before capture of the other of the first image data and the second image data.

12. The method of claim 11, wherein changing the first camera exposure level comprises using an exposure differentiation element that electronically controls the first sensor to change the first camera exposure level between the first exposure level and the second exposure level.

13. The method of claim 11, wherein changing the first camera exposure level comprises using an exposure differentiation element that modifies transmissivity of an optical pathway within the first camera to control a proportion of light entering the first camera that is received by the first sensor to change the first camera exposure level between the first exposure level and the second exposure level.

14. The method of claim 11, wherein:
changing the first camera exposure level comprises using a first exposure differentiation element that electronically controls the first sensor to change the first camera exposure level between the first exposure level and the second exposure level; and
changing the first camera exposure level further comprises using a second exposure differentiation element that modifies transmissivity of an optical pathway within the first camera to control a proportion of light entering the first camera that is received by the first sensor to change the first camera exposure level between the first exposure level and the second exposure level.

15. A non-transitory computer-readable medium for capturing a light-field image, comprising instructions stored thereon, that when executed by a processor, perform the steps of:
causing a first sensor of a light-field imaging system to capture first image data at a first exposure level;
causing an element selected from the group consisting of the first sensor and a second sensor of the light-field imaging system to capture second image data at a second exposure level different from the first exposure level;
causing a data store to receive the first image data and the second image data; and
combining the first image data and the second image data to generate a light-field image.

16. The non-transitory computer-readable medium of claim 15, wherein:
the element comprises the first sensor; and
the light-field imaging system comprises a plenoptic light-field camera comprising the first sensor, an aperture through which light enters the plenoptic light-field camera, and a microlens array positioned to direct the light onto the first sensor.

17. The non-transitory computer-readable medium of claim 16, wherein the plenoptic light-field camera is configured to carry out color differentiation through use of one or more color differentiation elements positioned at one or more of the first sensor, the aperture, and the microlens array.

18. The non-transitory computer-readable medium of claim 16, wherein the plenoptic light-field camera is configured to carry out exposure differentiation through use of one or more exposure differentiation elements positioned at one or more of the first sensor, the aperture, and the microlens array.

19. The non-transitory computer-readable medium of claim 15, wherein:
the light-field imaging system comprises a camera array comprising a plurality of cameras comprising at least a first camera having the first sensor and a second camera having a second sensor;
the element comprises the second sensor; and
the second camera has a second exposure setting different from a first exposure setting of the first camera.

20. The non-transitory computer-readable medium of claim 15, wherein:
the light-field imaging system comprises at least a first camera comprising the first sensor;
the element comprises the first sensor;
capturing the second image data comprises capturing the second image data non-simultaneously with capture of the first image data; and
the non-transitory computer-readable medium further comprises instructions stored thereon, that when executed by a processor, change a first camera exposure level of the first camera after capture of one of the first image data and the second image data, and before capture of the other of the first image data and the second image data.

21. The non-transitory computer-readable medium of claim 20, wherein changing the first camera exposure level comprises causing an exposure differentiation element to electronically control the first sensor to change the first camera exposure level between the first exposure level and the second exposure level.

22. The non-transitory computer-readable medium of claim 20, wherein changing the first camera exposure level comprises causing an exposure differentiation element to modify transmissivity of an optical pathway within the first camera to control a proportion of light entering the first camera that is received by the first sensor to change the first camera exposure level between the first exposure level and the second exposure level.

23. A system for capturing a light-field image, the system comprising:
a first sensor configured to capture first image data at a first exposure level;
a data store configured to receive the first image data and second image data captured at a second exposure level different from the first exposure level, by an element selected from the group consisting of the first sensor and a second sensor; and
a processor, communicatively coupled to the first sensor and the data store, configured to combine the first image data and the second image data to generate a light-field image.

24. The system of claim 23, wherein:
the element comprises the first sensor; and
the system further comprises a plenoptic light-field camera comprising at least the first sensor, an aperture through which light enters the plenoptic light-field camera, and a microlens array positioned to direct the light onto the first sensor.

25. The system of claim 24, further comprising one or more color differentiation elements positioned at one of the first sensor, the aperture, and the microlens array, configured to carry out color differentiation.

26. The system of claim 24, further comprising one or more exposure differentiation elements positioned at one of the first sensor, the aperture, and the microlens array, configured to carry out exposure differentiation.

27. The system of claim 23, further comprising a camera array comprising a plurality of cameras comprising at least a first camera having at least the first sensor and a second camera having a second sensor;
wherein:
the element comprises the second sensor; and
the second camera has a second exposure setting different from a first exposure setting of the first camera.

28. The system of claim 23, further comprising a first camera comprising at least the first sensor;
wherein:
the element comprises the first sensor;
capturing the second image data comprises capturing the second image data non-simultaneously with capture of the first image data; and
the first camera is further configured to change a first camera exposure level of the first camera after capture of one of the first image data and the second image data, and before capture of the other of the first image data and the second image data.

29. The system of claim 28, wherein the first camera is further configured to change the first camera exposure level by using an exposure differentiation element to electronically control the first sensor to change the first camera exposure level between the first exposure level and the second exposure level.

30. The system of claim 28, wherein the first camera is further configured to change the first camera exposure level by using an exposure differentiation element to modify transmissivity of an optical pathway within the first camera to control a proportion of light entering the first camera that is received by the first sensor to change the first camera exposure level between the first exposure level and the second exposure level.
